(19) United States
(12) Patent Application Publication
(10) Pub. No.: US 2026/0279037 A1
(43) Pub. Date: Sep. 17, 2026

(54) IMAGE PROCESSING SYSTEM AND NON-TRANSITORY COMPUTER-READABLE RECORDING MEDIUM FOR RECORDING IMAGE PROCESSING PROGRAM

(71) Applicant: AWL, Inc., Tokyo (JP)

(72) Inventors: Hiroshi FUJIMURA, Tokyo (JP); Fadoua GHOURABI, Tokyo (JP); Joo Ann WOO, Tokyo (JP); Wasu WASUSATEIN, Tokyo (JP); Kittinun AUKKAPINYO, Tokyo (JP); Intisar MD CHOWDHURY, Tokyo (JP)

(73) Assignee: AWL, Inc., Tokyo (JP)

(21) Appl. No.: 19/536,353

(22) Filed: Feb. 11, 2026

(30) Foreign Application Priority Data
Mar. 14, 2025 (JP) 2025-041885

(51) Int. Cl. G06V 10/82; G06F 3/0482; G06T 7/00; G06T 7/13

(52) U.S. Cl. CPC G06V 10/82; G06F 3/0482; G06T 7/0002; G06T 7/13; G06T 2207/10016

(57) ABSTRACT

The image processing system comprises an information extraction circuitry configured to extract, from one frame image or a plurality of temporally continuous frame images, local information which is information about a predetermined area or each object in the frame image and time information corresponding to the frame image, and a scene identification circuitry configured to identify a user's desired scene based on the local information and the time information extracted by the information extraction circuitry.

### CROSS–REFERENCE TO RELATED APPLICATION

This application is based on and claims the benefit of priority of the prior Japanese Patent Application No. 2025-041885, filed on Mar. 14, 2025, the entire contents of which are incorporated herein by reference.

### BACKGROUND OF THE INVENTION

### Field of the Invention

The present invention relates to an image processing system, and a non-transitory computer-readable recording medium for recording an image processing program.

### Description of the Related Art

In a fourth embodiment of the specification of Japanese Patent Application No. 2025-001868, the present applicant proposed an image display system in which an edge device side outputs text information related to a frame image in which a user's desired viewing target is likely to appear, and a cloud side selects a frame image, in which the user's desired viewing target appears, according to detailed criteria using the text information transmitted from the edge device side. In this embodiment, the edge device inputs each frame image into a model such as a vision language model (VLM) to extract text information from each frame image.

Inputting a frame image to the VLM as described above makes it easy to obtain outline text information (hereinafter, referred to as “global information”) about whole of the frame image from the frame image, but it is difficult to obtain text information about detailed content of the frame image. More specifically, when inputting a frame image to the VLM, if text information is extracted (obtained) from the frame image without inputting any words as a prompt (or with inputting a prompt such as “Please analyze and describe this image.”), text information about small objects in the frame image cannot be obtained (the small objects are ignored). Therefore, it is difficult to identify (search for) a user's desired scene using only this text information (the global information). On the other hand, if a prompt “Please analyze this image in detail.” is input when a frame image is input into the VLM, text information of a detailed analysis result about the frame image can be obtained. However, the obtained text information lacks versatility because the viewpoint of analyzing the frame image in detail depends on the frame image. Therefore, even if this text information is used, it is difficult to identify (search for) a user's desired scene.

### BRIEF SUMMARY OF THE INVENTION

An object of the present invention is to solve the problems described above, and to provide an image processing system, and a non-transitory computer-readable recording medium for recording an image processing program that make it possible to obtain information about detailed content of the frame image to accurately identify a user's desired scene using the obtained information about detailed content.

According to a first aspect of the present invention, this object is achieved by an image processing system comprising: an information extraction circuitry configured to extract, from one frame image or a plurality of temporally continuous frame images, local information which is information about a predetermined area or each object in the frame image and time information corresponding to the frame image; and a scene identification circuitry configured to identify a user's desired scene based on the local information and the time information extracted by the information extraction circuitry.

In the above configuration, because it is possible to obtain information about detailed content of the frame image (not outline information about whole of the frame image but information (local information) about a predetermined area or each object in the frame image), it is possible to accurately identify a user's desired scene using the obtained information about detailed content of the frame image.

According to a second aspect of the present invention, the above object is achieved by an image processing system comprising: an information extraction circuitry configured to extract, from one frame image or a plurality of temporally continuous frame images, global information which is outline information about whole of the frame image, local information which is information about a predetermined area or each object in the frame image, and time information corresponding to the frame image; and a scene identification circuitry configured to identify a user's desired scene based on the global information, the local information, and the time information extracted by the information extraction circuitry.

In the above configuration, because it is possible to obtain information about detailed content of the frame image (not only outline information (global information) about whole of the frame image but also information (local information) about a predetermined area or each object in the frame image), it is possible to accurately identify a user's desired scene using the obtained information about detailed content of the frame image.

According to a third aspect of the present invention, the above object is achieved by a non-transitory computer-readable recording medium for recording an image processing program to cause a computer to perform a process including the steps of: extracting, from one frame image or a plurality of temporally continuous frame images, local information which is information about a predetermined area or each object in the frame image and time information corresponding to the frame image; and identifying a user's desired scene based on the local information and the time information.

While the novel features of the present invention are set forth in the appended claims, the present invention will be better understood from the following detailed description taken in conjunction with the drawings.

### BRIEF DESCRIPTION OF THE DRAWINGS

The present invention will be described hereinafter with reference to the annexed drawings. It is to be noted that the drawings are shown for the purpose of illustrating the technical concepts of the present invention or embodiments thereof, wherein:

FIG. 1 is a schematic block diagram showing an outline of an image processing system according to a first embodiment of the present invention;

FIG. 2 is a schematic block diagram showing a hardware configuration of an edge device in FIG. 1;

FIG. 3 is a schematic block diagram showing a hardware configuration of a cloud server in FIG. 1;

FIG. 4 is a schematic block diagram showing a hardware configuration of a client in FIG. 1;

FIG. 5 is a schematic functional block diagram of the image processing system according to the first embodiment;

FIG. 6 is a flowchart illustrating an example of a scene identification procedure in the image processing system according to the first embodiment;

FIG. 7 is a flowchart illustrating an example of a scene identification procedure in the image processing system according to the first embodiment;

FIG. 8 is an explanatory diagram illustrating global information;

FIG. 9 is an explanatory diagram illustrating local information;

FIG. 10 is a flowchart illustrating an example of a display control procedure to be performed by the image processing system according to the first embodiment;

FIG. 11 is an explanatory diagram illustrating an example of an image to be displayed on the display of the client;

FIG. 12 is an explanatory diagram illustrating an example of an image to be displayed on the display of the client;

FIG. 13 is a schematic functional block diagram of the image processing system according to a modification of the first embodiment;

FIG. 14 is a schematic functional block diagram of the image processing system according to a second embodiment of the present invention;

FIG. 15 is a flowchart illustrating an example of procedures to be performed by an information extraction circuitry of the image processing system according to the second embodiment;

FIG. 16 is an explanatory diagram illustrating local information in the second embodiment;

FIG. 17 is a schematic functional block diagram of the image processing system according to a third embodiment of the present invention; and

FIG. 18 is a flowchart illustrating an example of a procedure to be performed by a secondary scene identification circuitry in the image processing system according to the third embodiment.

### DETAILED DESCRIPTION OF THE INVENTION

The present disclosure will be specifically described with reference to the drawings illustrating embodiments thereof. In the following embodiments, an image processing system of the present disclosure will be described.

### First Embodiment

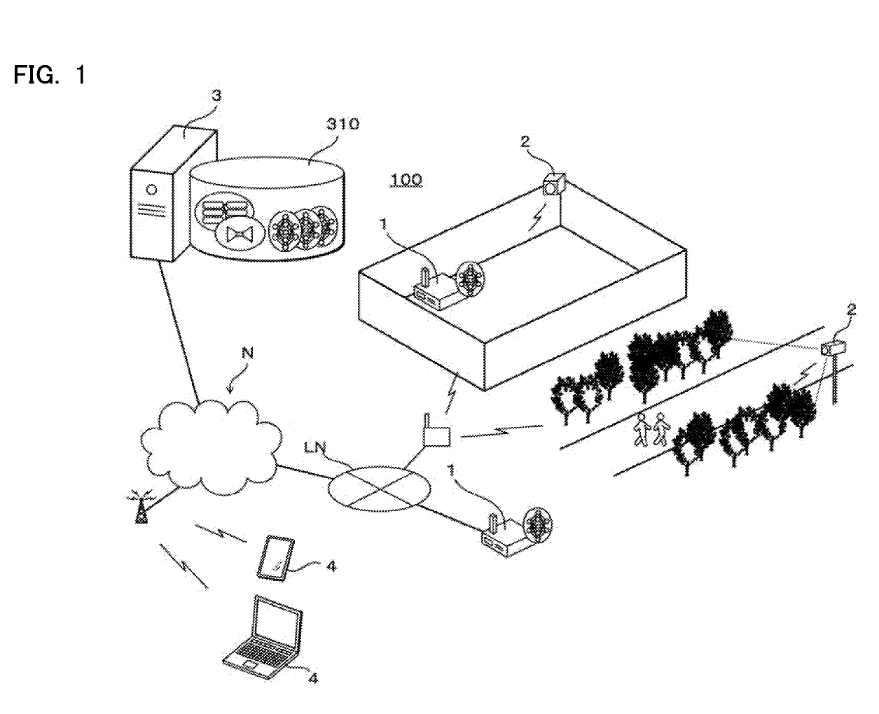

FIG. 1 is a schematic diagram of an image processing system 100 according to a first embodiment of the present invention. The image processing system 100 is installed in a specific space (a target space) inside and outside a store. The image processing system 100 includes a camera 2 installed in the target space, an edge device 1 connected to the camera 2, a cloud server 3 capable of communicative connection to the edge device 1, and a client 4 capable of communicative connection to the cloud server 3. A plurality of edge devices 1 and a plurality of cameras 2 may be installed in the same space.

The camera 2 outputs image information by using an image element corresponding to visible light and/or near-infrared light. The camera 2 outputs image information in time series at a rate of several fps to several tens of fps. The camera 2 may be installed so as to look down the target space from a high place such as a ceiling or a shelf of a store as the target space. The camera 2 may be of a type attached to a ceiling and may include a 360-degree space in an angle of view. The camera 2 may be installed on a utility pole or the like so as to look down an outdoor area as the target space.

The camera 2 and the edge device 1 can be communicatively connected to each other via a wireless or wired local network LN. The local network LN is installed in a facility including the target space. The local network LN may be a wired local area network (LAN) or a wireless network such as WiFi and Bluetooth. The camera 2 sequentially transmits image information to the edge device 1 via the local network LN.

The edge device 1 can be communicatively connected to the cloud server 3 via the network N. The network N is a wired or wireless communication network that may include a public communication network, a dedicated line, or a carrier network. The client 4 can be communicatively connected to the cloud server 3 and the edge device 1 via the network N.

The cloud server 3 holds pre-trained learning models to be used in respective processes to be selectively performed by the edge device 1 and the cloud server 3 in a database 310. The database 310 may include pre-trained learning models provided from an external service outside the image processing system 100. The cloud server 3 reads, from the database 310, respective pre-trained learning models corresponding to respective objects to be detected by respective processes to be performed by the edge device 1 and the cloud server 3, and deploys the pre-trained learning models to the edge device 1 and the cloud server 3.

The image processing system 100 according to the first embodiment extracts a feature amount from an image captured by the camera 2 installed in a target space, detects an object such as a person from the image based on the feature amount, recognizes an attribute of the detected object, and outputs a recognition result. The image processing system 100 is a system that enables the client 4 to automatically display a user's desired scene in which the user's desired object appears.

In the image processing system 100 according to the first embodiment, the user can select attributes of a person or an object as a detection object. The selected attributes are used for determining whether or not a scene in which the detection object having the selected attributes appears is a user's desired scene. In the image processing system 100 of the first embodiment, it is possible to suppress the amount of communication between the edge device 1 and the cloud server 3, and to suppress the processing load on the edge device 1 by sharing the processing between the edge device 1 and the cloud server 3.

Hereinafter, configurations of the edge device 1, the cloud server 3, and the client 4 for realizing this image processing system 100 and details of processing executed by each of them will be described.

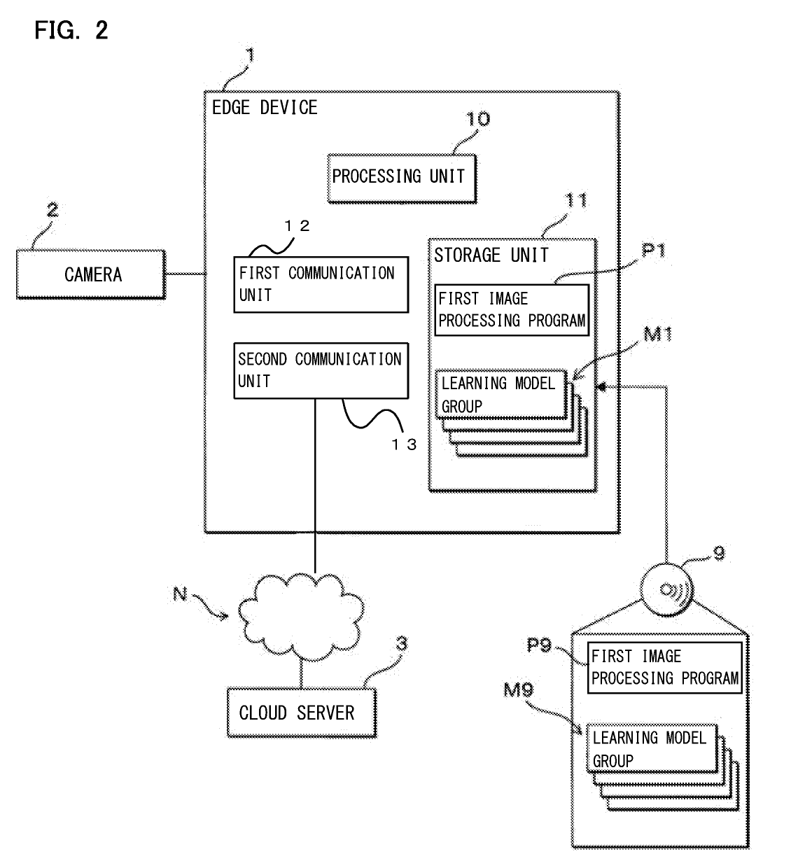

FIG. 2 is a block diagram illustrating a configuration of the edge device 1. The edge device 1 is a box-type device that can be disposed together with the camera 2 in the target space. The edge device 1 includes a processing unit 10, a storage unit 11, a first communication unit 12, and a second communication unit 13.

The processing unit 10 includes one or more processors such as a central processing unit (CPU), a micro-processing unit (MPU), a graphics processing unit (GPU), or a neutral processing unit (NPU). The processing unit 10 includes a memory that is a temporary storage medium such as a static random access memory (SRAM) or a dynamic random access memory (DRAM). The processing unit 10 includes a timer, and can acquire time information at each time point from the timer. The processing unit 10 may be configured as one piece of hardware (SoC: system on a chip) in which a processor, a memory, the storage unit 11, the first communication unit 12, and the second communication unit 13 are integrated. The specifications of respective processing units 10 in the image processing system 100 may be the same or different among the edge devices 1.

The processing unit 10 reads the first image processing program P1 stored in the storage unit 11 into the memory and executes the first image processing program P1 to cause the processor to execute various processes to be described later and function as the edge device 1 of the present disclosure.

The storage unit 11 is a relatively large-capacity non-transitory storage medium such as a hard disk or a flash memory. A part of the storage unit 11 may be removable.

The storage unit 11 stores a program (program product) necessary for the processing unit 10 to perform processing, a processing result of the processing unit 10, and setting information for reference. The setting information includes identification data of the edge device 1, identification data of the camera 2 to be connected, and the like. The setting information includes setting of criteria for distinguishing global information and local information of an image to be described later. The setting of criteria defines, for example, an area in the image corresponding to the local information. The area may be a specific area in the image set by the user from the client 4, or may be obtained by dividing the frame image into a plurality of areas. The criteria may include a criterion whether the detected bounding box is to be used.

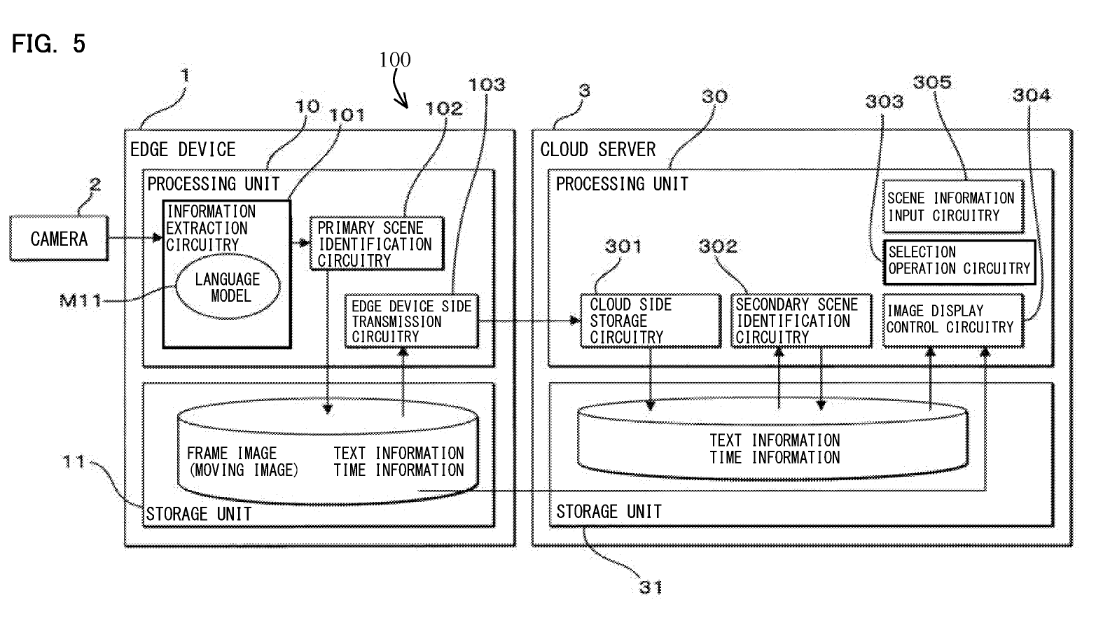

The setting information stored in the storage unit 11 includes information to be referred in order to identify a user's desired scene. The information for identifying a user's desired scene includes, for example, text indicating a user's desired object such as “human.” The text may be “dog ” or“ dangerous animal ”, or may be text indicating an attribute such as “adult”, “wearing a hat/cap”, or “wearing glasses.” The text indicating a user's desired object is set based on the scene information input by the user using the client 4 via the cloud server 3 (see “scene information input circuitry 305” in FIG. 5).

The program product stored in the storage unit 11 includes an operating system (OS) program, a first image processing program P1, and a learning model group M1. The learning model group M1 will be described in detail later. The first image processing program P1 and the learning model group M1 stored in the storage unit 11 may be the first image processing program P9 and the learning model group M9 stored in the computer-readable non-transitory storage medium 9 and be read from the computer-readable storage medium 9 to be stored in the storage unit 11 by the processing unit 10, or may be stored in the storage unit 11 prior to shipment of the edge device 1. The first image processing program P1 or the learning model group M1 stored in the storage unit 11 may be downloaded by the processing unit 10 from the database 310 of the cloud server 3 or from another download server via the second communication unit 13.

The storage unit 11 stores image information that can be acquired from the connected camera 2 in time series in association with time information. The image information may be a frame image or a moving image. The storage unit 11 stores only image information that is a frame image in which a user's desired object (viewing target) is detected, or a moving image composed of previous and subsequent frame images including the frame image in which the user's desired object is detected, as a result of processing of the processing unit 10 to be described later. The storage unit 11 may continue to overwrite and store data according to a first in first out (FIFO) method within a range corresponding to the size of the capacity. The storage unit 11 may store text information describing the detected object, text information indicating an attribute of the detected object, and the like in association with time information.

The first communication unit 12 is a communication device that realizes communication via a local network LN installed in the target space. The first communication unit 12 may be a LAN network card or a controller area network (CAN) communication device. The first communication unit 12 may be a communication device compatible with a wireless network such as WiFi or Bluetooth. The first communication unit 12 may include a plurality of communication devices corresponding to various types of cameras 2. The first communication unit 12 may include an interface such as a universal serial bus (USB) to be connected to the camera 2. The first communication unit 12 can be replaced with an interface to be connected to the camera 2 via a coaxial cable or another serial bus. The processing unit 10 acquires image information from the camera 2 via the local network LN by the first communication unit 12. The first communication unit 12 may be the same device as the second communication unit 13 to be described later.

The second communication unit 13 is a communication device that realizes communication via the external network N. The second communication unit 13 may be a wired LAN network card or a communication device that realizes carrier communication via a carrier network. The second communication unit 13 may be a communication device compatible with a wireless network such as WiFi or Bluetooth. The second communication unit 13 may support secure communication such as secure socket layer (SSL) with the cloud server 3. The second communication unit 13 may be an interface for realizing communication connection with the cloud server 3 via a dedicated line.

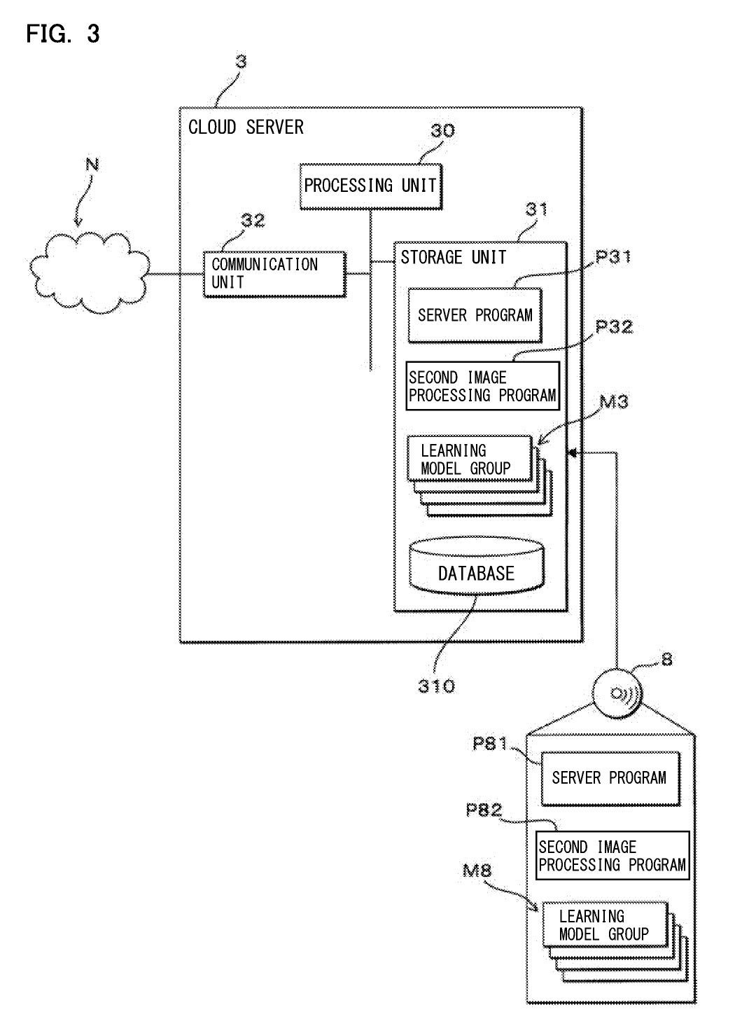

FIG. 3 is a block diagram illustrating a configuration of the cloud server 3. The cloud server 3 may be configured by one server computer or may be configured to distribute processing among a plurality of server computers. The cloud server 3 comprises a processing unit 30, a storage unit 31, and a communication unit 32.

The processing unit 30 includes one or more processors such as CPUs, MPUs, GPUs, and NPUs. The processing unit 30 includes a memory that is a temporary storage medium such as an SRAM or a DRAM.

The storage unit 31 is a relatively large-capacity non-transitory storage medium such as a hard disk or a flash memory. The storage unit 31 stores a program (program product) and setting information necessary for the processing unit 30 to execute processing to be described later.

The program product stored in the storage unit 31 includes a server program P31. The server program P31 includes a module which functions as a data server that reads a model group stored in the database 310 and transmits the model group to the edge device 1. The server program P31 includes a module that functions as a Web server, and can output a result of processing executed by the cloud server 3 to the client 4 by a Web page.

The program product stored in the storage unit 31 includes a second image processing program P32 operating on the cloud server 3 and a learning model group M3. The second image processing program P32 is a program that causes the processing unit 30 to execute processing in cooperation with the processing based on the first image processing program P1 in the edge device 1. The learning model group M3 is selected from pre-trained learning models in the database 310 and stored into the storage unit 31. The second image processing program P32 and the learning model group M3 will be described in detail later.

The server program P31 and the second image processing program P32 stored in the storage unit 31 may be obtained in a way that the processing unit 30 reads the server program P81 and the second image processing program P82 stored in the computer-readable non-transitory storage medium 8 to store the server program P81 and the second image processing program P82 into the storage unit 31. The learning model group M3 may also be obtained in a way that the processing unit 30 reads the learning model group M8 stored in the non-transitory storage medium 8 to store the learning model group M8 into the storage unit 31. The server program P31 and the second image processing program P32 stored in the storage unit 31 may be downloaded by the processing unit 30 from another download server via the communication unit 32.

The setting information stored in the storage unit 31 includes data showing a correspondence relationship between data or a name for identifying a space, in which the edge device 1 is installed, and identification data of the edge device 1. The cloud server 3 may store identification data of an edge device 1 or a target space, for which a setting change by the user is permitted, into the storage unit 31 as a white list in association with the user’s account data in order to execute processing on a plurality of target spaces simultaneously. Thus, when the user designates the name of a target space and designates which object is to be detected in an image captured by the camera 2 installed in the target space, the cloud server 3 can specify the target edge device 1.

The setting information stored in the storage unit 31 includes information which is referred in order to identify a user's desired scene and is described later. The information for identifying a user's desired scene on the cloud server 3 side is information for further identifying a scene than the corresponding information on the edge device 1 side. The information for further identifying a scene is, for example, text indicating a user's desired scene such as “a scene in which a plurality of persons are walking”, “a scene in which more than one person stays in the same place for more than five minutes”, and “a scene in which a dangerous animal is approaching a person.”

The storage unit 31 stores image information including a scene which is captured by the camera 2 and identified by the scene identification process. The image information may be a frame image identified by the scene identification process, or a moving image composed of previous and subsequent frame images including the frame image identified by the scene identification process.

The database 310 may be constructed in the storage unit 31 or may be constructed in an external storage device. A part of the database 310 may include the model providing service to be used on the Web communicatively connected via the network N as described above. The database 310 holds a learning model group to be used in processes to be executed by the edge device 1 and the cloud server 3. The learning model group includes, for example, detection learning models such as a person detector, a head detector, a face detector, an animal detector, and a specific device detector. The learning model group further includes a recognition learning model such as an age recognizer, a glasses wearing recognizer, a hat wearing recognizer, a face orientation recognizer, or a posture recognizer. The learning model group includes a large language model (LLM), a small language model (SLM), a vision language model (VLM), and the like.

The communication unit 32 is a communication device that realizes communication connection with the client 4 and the edge device 1 via the network N.

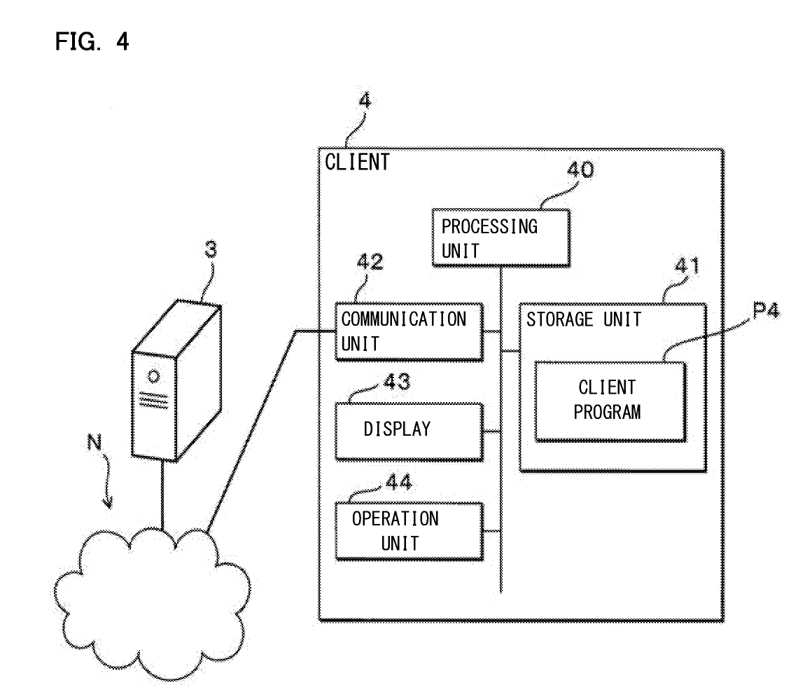

FIG. 4 is a block diagram showing the configuration of the client 4. The client 4 is a personal computer, a smartphone, or a tablet terminal. The client 4 may be used by a manager of a space in which the camera 2 is installed, or may be used by an operator of a management company of the cloud server 3.

The client 4 comprises a processing unit 40, a storage unit 41, a communication unit 42, a display 43, and an operation unit 44. The processing unit 40 includes one or more processors such as a CPU, an MPU, a GPU, and an NPU. The processing unit 40 includes a memory that is a temporary storage medium such as an SRAM or a DRAM.

The storage unit 41 is a memory of a non-transitory storage medium such as a hard disk or a flash memory. The storage unit 41 stores a module to use the function of the data server to be provided by the cloud server 3, and a client program P4 to function as the Web client. The client program P4 is, for example, a Web browser program. The client program P4 is a program that causes the processing unit 40 to execute a process of displaying various data including an image provided from the cloud server 3 on the screen.

The communication unit 42 is a communication device that realizes communication connection with the cloud server 3 via the network N. The communication unit 42 may be a communication device that realizes communication connection with the cloud server 3 via a dedicated line. The communication unit 42 may be a communication device that realizes direct communication connection with the second communication unit 13 of the edge device 1 via a wireless communication medium, a USB cable, or the like.

The display 43 is a display such as a liquid crystal display or an organic electro luminescence (EL) display. The display 43 displays a Web page including characters and images by processing of the processing unit 40 according to the client program P4. The display 43 may be a display with a built-in touch panel.

The operation unit 44 is a user interface such as a keyboard or a pointing device that receives an operation from a user. The operation unit 44 may be a touch panel built in the display 43 or a physical button. The operation unit 44 may be a voice input unit and receive an operation by voice using a voice recognition function. The operation unit 44 can notify the processing unit 40 of user’s operations.

In the image processing system 100 configured as described above, the edge device 1 and the cloud server 3 perform distributed processing for an image captured by the camera 2 in each space, and make the client 4 be able to display image information of the user's desired scene on the display 43 so that the user can view the image information. In the image processing system 100 according to the first embodiment, the edge device 1 executes a process of identifying a scene in which a user's desired object is likely to appear. In the image processing system 100, the cloud server 3 executes a process of secondarily identifying a scene, in which a user's desired object reliably appears, from frame images corresponding to scenes primarily identified on the edge device 1 side. In the present disclosure, text information describing what appears in a frame image is extracted as a result of primarily identifying a scene on the edge device 1 side, and not image information of the identified scene but the text information extracted from the image information is transmitted to the cloud server 3. Thus, in the image processing system 100, as compared with the case where the edge device 1 transmits image information of the identified scene to the cloud server 3, data traffic can be reduced while considering personal information.

FIG. 5 is a functional block diagram of the image processing system 100. In the image processing system 100, the functions illustrated in FIG. 5 are fulfilled by the edge device 1 and the cloud server 3 according to the first image processing program P1 of the edge device 1 and the second image processing program P32 of the cloud server 3. In the image processing system 100, the processing unit 10 of the edge device 1 functions as an information extraction circuitry 101, a primary scene identification circuitry 102, and an edge device side transmission circuitry 103, and the processing unit 30 of the cloud server 3 functions as a cloud side storage circuitry 301, a secondary scene identification circuitry 302, a selection operation circuitry 303, an image display control circuitry 304, and a scene information input circuitry 305.

In the first embodiment, the information extraction circuitry 101 receives a frame image obtained by the camera 2 through the first communication unit 12. The information extraction circuitry 101 extracts text-based visual information from the acquired frame image. The information extraction circuitry 101 uses the language model M11 to extract text-based information representing an object such as a person appearing in the frame image and an attribute of the object. That is, the language model M11 includes functions of an object detection model and a recognition model for recognizing an attribute of a detected object. The information extraction circuitry 101 may use the language model M11 to obtain information in which information estimated from attributes, arrangement, and the like of an object appearing in the frame image is described in a text format. As the language model M11, a multimodal model (for example, a vision language model (VLM)), into which an image can be input, is selected from the database 310 and stored in the storage unit 11. Further, a verbalization process using the language model M11 is deployed in the edge device 1.

The information extraction circuitry 101 gives an instruction to the language model M11 such as VLM so that the language model M11 describes a sentence or a word representing a person or an object appearing in the entire frame image, and obtains text-based information output from the language model M11 as global information that is outline information about whole of the frame image. The information extraction circuitry 101 gives an instruction to the language model M11 such as VLM so that the language model M11 describes a sentence or a word representing a person or an object appearing in a specific area of the frame image, and obtains text-based information output from the language model M11 as local information that is information about a specific area or each object in the frame image.

The information extraction circuitry 101 extracts text-based outline information such as “Three people are walking.”, “A plurality of autumn trees appear.”, and “A specific animal appears in the shade of a tree.” from a frame image as the global information about whole of the frame image. The information extraction circuitry 101 extracts text-based information such as “One person (who is from 50 to 69 years old) is walking, and a specific animal is in the shade of a tree beside a road on which the person is walking.” or “Two persons (one wears a hat and the other wears glasses) are walking.” from a frame image as the local information regarding a specific area or each object in the frame image.

The information extraction circuitry 101 extracts time information of a target frame image together with global information and local information from the target frame image. In this example, an example in which the information extraction circuitry 101 extracts, from one frame image, global information and local information for the frame image and time information corresponding to the frame image is mainly described. However, the present invention is not limited to this, and the information extraction circuitry 101 may extract, from a plurality of temporally continuous frame images (that is, a moving image), global information, local information and time information corresponding to the plurality of temporally continuous frame images.

Based on the global information or the local information extracted by the information extraction circuitry 101, the primary scene identification circuitry 102 identifies whether or not a user's desired object is likely to appear in the target frame image. Similar to the secondary scene identification circuitry 302 described later, the primary scene identification circuitry 102 may include an LLM. Specifically, the primary scene identification circuitry 102 may input at least one of the global information and the local information to the LLM together with a text instructing to analyze whether a user's desired object is likely to appear in the target frame image, and identify whether the user's desired object is likely to appear in the target frame image based on the result output from the LLM. When the user's desired object is likely to appear in the target frame image, the primary scene identification circuitry 102 identifies the target frame image as an image that is likely to be a part of the user's desired scene. The primary scene identification circuitry 102 stores the frame image corresponding to the identified scene in the storage unit 11 in association with the time information extracted by the information extraction circuitry 101. The primary scene identification circuitry 102 stores a moving image for a predetermined time before and after the frame image corresponding to the identified scene into the storage unit 11. When the primary scene identification circuitry 102 selects temporally continuous frame images, the primary scene identification circuitry 102 may store the frame images as a series of moving images. The primary scene identification circuitry 102 discards unidentified frame images. When the processing unit 10 identifies that the user's desired object does not appear in the target frame image based on the output from the information extracting circuitry 101 as the primary scene identification circuitry 102, the processing unit 10 ends the processing for the target frame image without executing the subsequent processing for the target frame, and executes the processing for the next frame image.

The primary scene identification circuitry 102 stores the global information and the local information extracted from the target frame image by the information extraction circuitry 101 in the storage unit 11 together with the frame image and the time information of the identified scene.

In the first embodiment, the edge device side transmission circuitry 103 transmits text-based global information and local information corresponding to the frame image identified by the primary scene identification circuitry 102, and time information corresponding to the frame image to the cloud server 3 by the second communication unit 13. The edge device side transmission circuitry 103 transmits the text-based global information, local information, and time information corresponding to the target frame image in association with identification data of the edge device 1. The time information is text information indicating a time corresponding to the frame image, an elapsed time or count from a specific time, or the like.

The cloud side storage circuitry 301 receives the global information describing the outline of the identified frame image, the local information describing the information of the specific area in the frame image, the time information corresponding to the frame image, and the identification data of the edge device 1 which are transmitted from the edge device 1 by the edge device side transmission circuitry 103. The cloud side storage circuitry 301 stores the received information into the storage unit 31. Image information is not transmitted from the edge device 1 to the cloud server 3.

The secondary scene identification circuitry 302 uses the global information, the local information, and the time information in the text format stored in the storage unit 31 by the cloud side storage circuitry 301 to identify a scene in which a user's desired object appears according to detailed criteria, and stores the time information of the identified scene in the storage unit 31. The detailed criteria include criteria for an attribute for determining that each object detected in each frame image is a user’s desired object with respect to each frame image in which the user's desired object is detected by the primary scene identification circuitry 102 on the edge side. The detailed criteria are, for example, criteria for an attribute of a person in a case where it is detected that the person appears by the primary scene identification circuitry 102. For example, when the primary scene identification circuitry 102 identifies a scene in which a person appears, the secondary scene identification circuitry 302 identifies a scene in which a person with specific clothes or a person with a specific face direction appears.

Another example of identification criteria may be used as long as the criteria for scene identification in the secondary scene identification circuitry 302 is more detailed than the criteria for scene identification in the primary scene identification circuitry 102. The secondary scene identification circuitry 302 identifies a scene, in which the user's desired object appears with high probability, out of scenes identified by the primary scene identification circuitry 102. The detailed selection criteria in the secondary scene identification circuitry 302 are, for example, criteria according to which the secondary scene identification circuitry 302 can reliably determine that a person having a user’s desired attribute appears in a scene, in the case where the primary scene identification circuitry 102 identifies that an object as large as a person appears in the frame images corresponding to the scene and the scene includes a person.

The secondary scene identification circuitry 302 may input either the global information or the local information corresponding to the frame image identified by the primary scene identification circuitry 102 to the LLM together with an instruction to analyze whether a user's desired object appears, and identify whether or not the frame image identified by the primary scene identification circuitry 102 corresponds to the user's desired scene based on the result output from the LLM.

The secondary scene identification circuitry 302 may delete information other than the time information, the global information, and the local information corresponding to the scene identified by the secondary scene identification circuitry 302 out of the time information, the global information, and the local information stored by the cloud side storage circuitry 301.

The selection operation circuitry 303 performs control such that a selection operation of scenes to be displayed on the display 43 of the client 4 connected to the cloud server 3 from among scenes narrowed down by the secondary scene identification circuitry 302 is performed using the operation unit 44 of the client 4. The processing unit 30 receives a selection operation on a Web page displayed on the client 4 based on a Web server module included in the server program P31.

The image display control circuitry 304 performs control to display the scenes narrowed down by the identification of the secondary scene identification circuitry 302 on the display 43 of the client 4 connected to the cloud server 3. Specifically, the image display control circuitry 304 performs control to extract frame images corresponding to the user’s desired scenes identified by the secondary scene identification circuitry 302 from the moving image stored in the storage unit 11 of the edge device 1, and display the frame images on the display 43 of the client 4. The processing unit 30 may redirect a frame image corresponding to time information designated by the user from the client 4 toward the client 4 using the edge device 1 as a host. When the processing unit 30 makes the edge device 1 directly transmit a frame image or a moving image to the client 4, it is possible to avoid storing data (the frame image or the moving image) in the cloud server 3.

The scene information input circuitry 305 has a function of receiving input of scene information for setting an object to be detected. The scene information is information which is a basis for scene identification by the primary scene identification circuitry 102 and the secondary scene identification circuitry 302. The processing unit 30 receives, by the scene information input circuitry 305, input of the scene information indicating what kind of scene the user wants to browse for the target space in association with the identification data of the target space via the client 4 in advance before the processing described later is started. The scene information is the keyword of the object to be detected. The scene information is, for example, “human”, “dog”, or the like as described above, and may be an attribute such as “adult”, “wearing a hat/cap”, or “wearing glasses.” The processing unit 30 stores the setting information to be referred to by the primary scene identification circuitry 102 into the storage unit 11 of the edge device 1, and stores the setting information to be referred to by the secondary scene identification circuitry 302 into the storage unit 31 of the cloud server 3, according to the scene information received by the function of the scene information input circuitry 305.

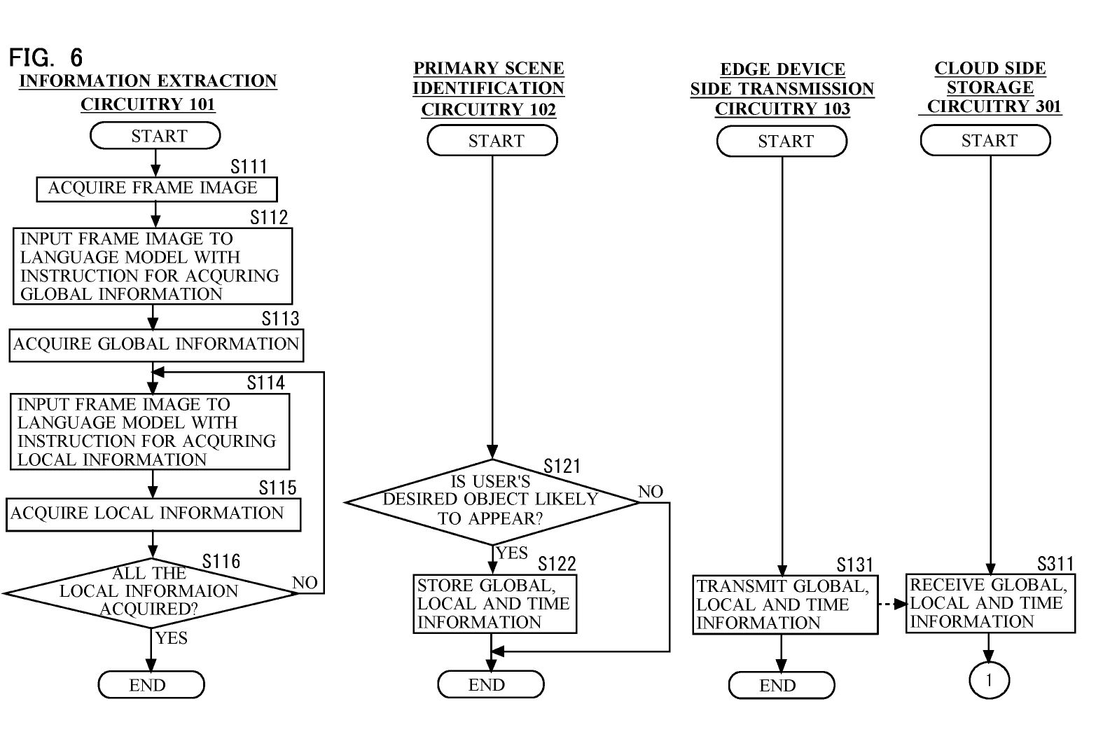

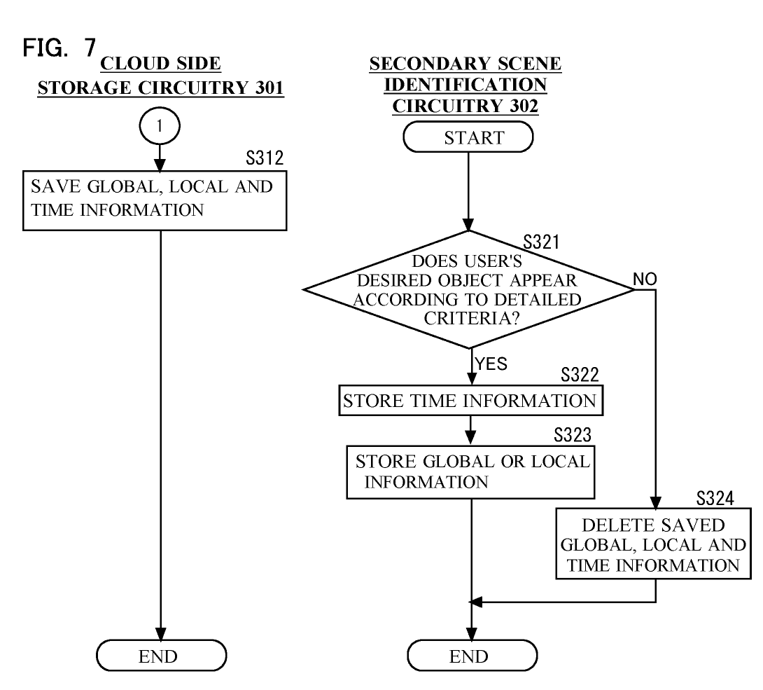

A procedure of each function (each circuitry) of the image processing system 100 illustrated in FIG. 5 will be described with reference to a flowchart. FIGS. 6 and 7 are flowcharts illustrating an example of procedures of scene identification processing in the image processing system 100. Before the operation of the image processing system 100 is started, information for identifying the user’s desired scene for each target space is input by the scene information input circuitry 305. After the operation is started, the image processing system 100 executes the following processing.

The processing unit 10 of the edge device 1 acquires a frame image from the camera 2 (step S111).

By the function of the information extraction circuitry 101, the processing unit 10 inputs the acquired frame image to the language model M11 together with an instruction for acquiring global information (step S112). In step S112, the processing unit 10 creates a sentence such as “Analyze what appears in this image.” as an instruction for acquiring the global information, and inputs the sentence to the language model M11 together with the frame image. The processing unit 10 may create a sentence of instruction to be given to the language model M11, or may read the sentence of instruction from a set of predetermined sentences stored in the storage unit 11.

The processing unit 10 acquires text information, which is a sentence or one or more words output from the language model M11 in response to the input in step S112, as global information (step S113).

Next, for the frame image acquired in step S111, the processing unit 10 extracts a specific area in the acquired frame image and inputs the specific area to the language model M11 together with an instruction for acquiring local information (step S114). In step S114, the processing unit 10 creates, as an “instruction” for acquiring local information, image data obtained by extracting a specific area portion set in the setting data and a sentence such as “Analyze what appears in a designated portion of this image”, and inputs the image data and the sentence to the language model M11 together with the frame image. Also in step S114, the sentence of instruction given to the language model M11 may be read from a set of predetermined sentences stored in the storage unit 11. In step S114, the processing unit 10 may designate a range by coordinates in the “instruction” instead of extracting an area from the frame image.

The processing unit 10 acquires text information, which is a sentence or one or more words output from the language model M11 in response to the input in step S114, as local information (step S115).

The processing unit 10 determines whether or not all the local information for the frame image acquired in step S111 has been acquired (step S116). When the processing unit 10 does not determine that all the local information has been acquired (NO in step S116), the processing unit 10 returns the process to step S114 to execute the process for another area in the frame image.

When determining that all the local information has been acquired (YES in step 116), the processing unit 10 ends the processing as the information extraction circuitry 101.

The processing unit 10 determines whether or not a user's desired object is likely to appear in the frame image acquired in step S111 based on the extracted global information and local information by the function of the primary scene identification circuitry 102 (step S121).

In step S121, the processing unit 10 determines whether the text of the global information and the local information matches a part of the text set in the setting information.

When determining that the user's desired object is likely to appear in the frame image (YES in step 121), the processing unit 10 stores the global information, the local information, and the time information indicating the time, at which the frame image is captured, into the storage unit 31 (step S122). The primary scene identification circuitry 102 of the processing unit 10 ends the processing for the frame image acquired in step S111.

When determining that the user's desired object is not likely to appear in the frame image (NO in step 121), the processing unit 10 ends the processing for the frame image acquired in step S111. Also in this case (NO in step 121), the acquired frame image does not have to be stored in the storage unit 11.

When the frame image corresponding to the scene identified by the primary scene identification circuitry 102 is stored (saved) in the storage unit 11, the processing unit 10 of the edge device 1 transmits the global information, the local information, and the time information corresponding to the frame image to the cloud server 3 by the function of the edge device side transmission circuitry 103 (step S131). In step S131, the processing unit 10 transmits also the identification data of the edge device 1 to the cloud server 3. Accordingly, the cloud server 3 corresponding to the plurality of target spaces can specify in which target space the frame image is captured.

On the cloud server 3 side, the processing unit 30 receives the global information, the local information, the time information, and the identification data of the edge device 1 transmitted from the edge device 1 by the function of the cloud side storage circuitry 301 (step S311). The processing unit 30 saves (stores) the received global information, local information, and time information in the storage unit 31 in association with the identification data of the edge device 1 received together with these information (step S312), and ends the reception and storage (saving) processing.

Each time the global and local information are stored in the storage unit 31, the processing unit 30 determines whether or not the user's desired object appears in the target frame image based on the stored global and local information according to the detailed criteria by the function of the secondary scene identification circuitry 302 (step S321). In step S321, the processing unit 30 may determine based on not only the global and local information of the target frame image but also the global and local information corresponding to the previous or subsequent frame images of the target frame image in time series.

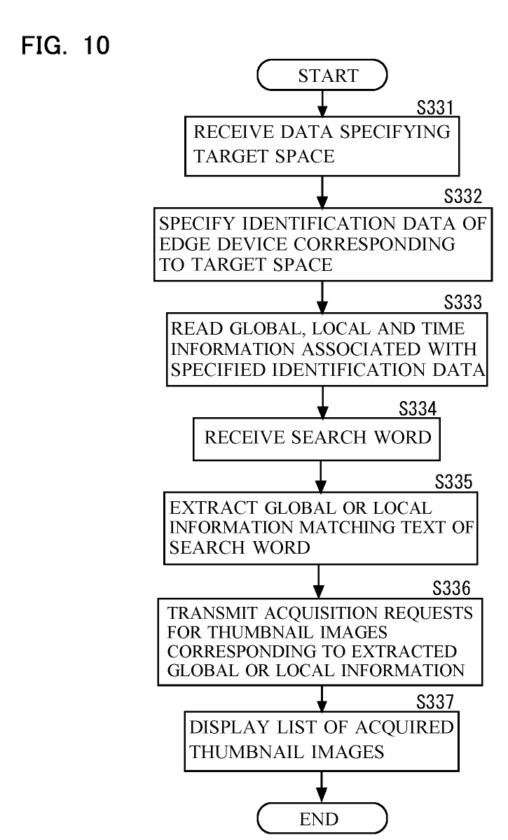

When determining that the user's desired object appears in the frame image corresponding to the stored global and local information according to the detailed criteria (YES in step 321), the processing unit 30 stores the time information corresponding to the frame image in the storage unit 31 (step S322). In the case where the processing unit 30 stores the time information continuous in time series (temporally) in step S322, the processing unit 30 may store information of a period. The processing unit 30 stores, in the storage unit 31, the global information or the local information that is the basis for determining that the user's desired object appears in the target frame image, in association with the time information corresponding to the targe frame image (step S323). However, because the process of step S323 means storing text for search, the process is not necessary when text-based search described in FIG. 10 is not accepted in the image processing system 100.

When determining that the user's desired object does not appear in the frame image corresponding to the stored global and local information (NO in step 321), the processing unit 30 deletes the global information, local information, and time information stored (saved) in the storage unit 31 by the cloud side storage circuitry 301 from the storage unit 31 (step S324).

According to the procedure illustrated in FIGS. 6 and 7, the frame image stored on the edge device 1 side corresponding to the time information stored in the storage unit 31 of the cloud server 3 becomes the frame image included in the scene identified by the secondary scene identification circuitry 302. In the cloud server 3, the time information, the global information, and the local information of the frame image corresponding to the identified scene are stored.

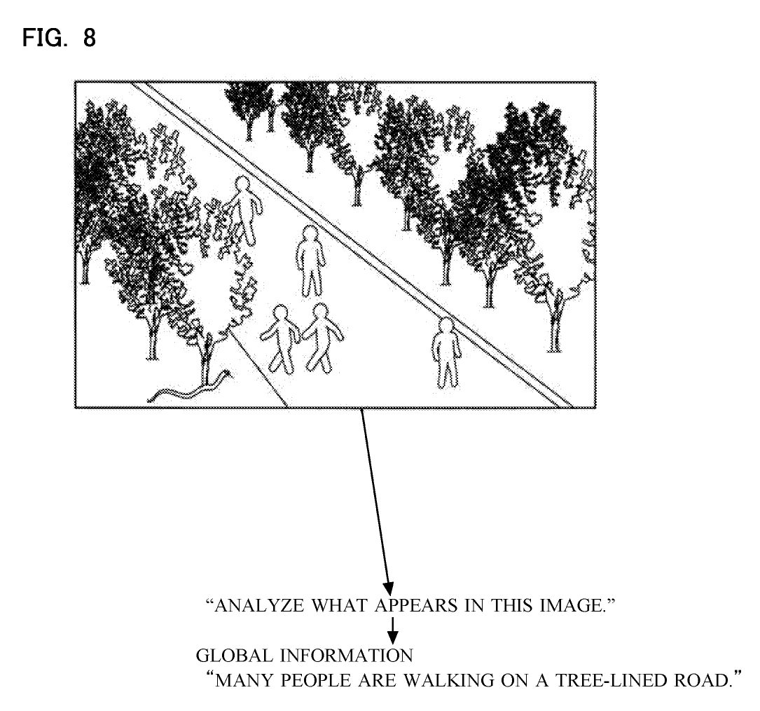

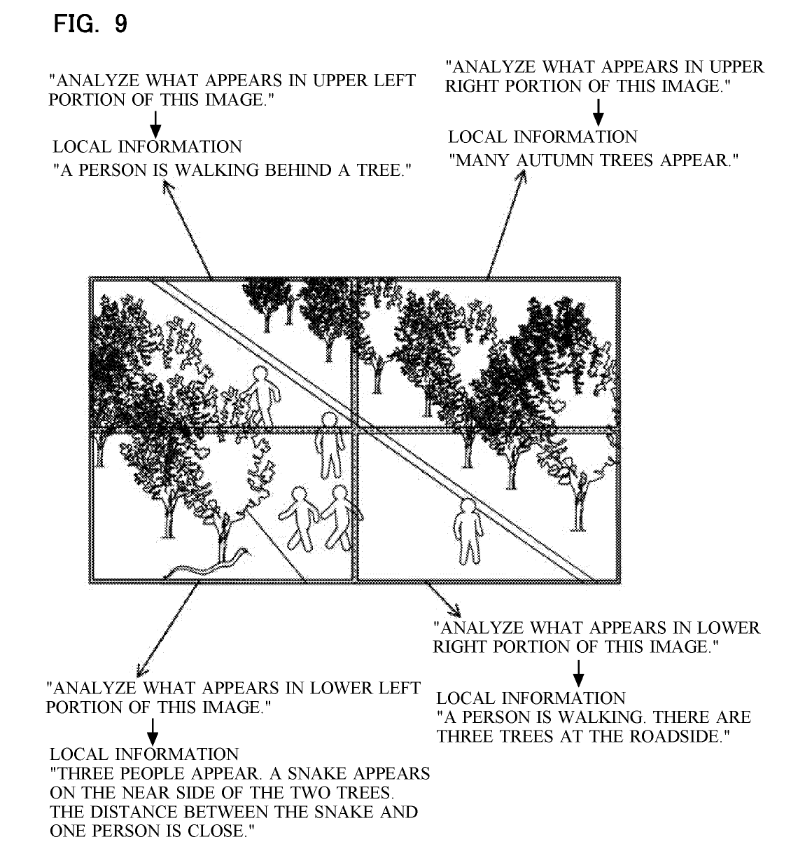

FIGS. 8 and 9 are explanatory diagrams of the global information and the local information. FIGS. 8 and 9 are diagrams schematically illustrating an example of a frame image obtained from the camera 2 installed in the outdoor walkway of the facility. In the frame image shown in FIG. 9, grid lines that divide the frame image into a plurality of areas are indicated by broken lines.

FIG. 8 shows an example of global information indicating an outline about whole of the frame image. As shown in FIG. 8, the global information is output from the language model M11, when an instruction “Analyze what appears in this image.” is input to the language model M11 together with the entire frame image. In the example shown in FIG. 8, the global information as the analysis result of the entire frame image is “Many people are walking on a tree-lined road.” This analysis result is expressed in text.

FIG. 9 illustrates an example of local information in the case where each area obtained by vertically and horizontally dividing a frame image into four areas by grid lines is designated as a specific area in the frame image. In the example of FIG. 9, the local information is output from the language model M11 when the information extraction circuitry 101 gives to the language model M11 an instruction “Analyze what appears in a designated portion of this image.” while designating a specific area of the frame image. In the example of FIG. 9, the local information obtained by designating the upper left portion is “A person is walking behind a tree.” In this case, information having a clear depth and a clear positional relationship is shown. The local information obtained by designating the upper right portion is “Many autumn trees appear.” This information indicates that the upper right portion of the entire frame image is recognized as an area in which trees rather than a person appear. The local information obtained by designating the lower left portion is “Three people appear. A snake appears on the near side of the two trees. The distance between the snake and one person is close.” This local information clearly describes the number of the detected object, existence of a small dangerous animal which is not described in the global information, and the positional relationship between the small dangerous animal and the detected person in detail. The local information obtained by designating the lower right portion is “A person is walking. There are three trees at the roadside.” This local information clearly and precisely describes the number of the detected object.

As shown in FIG. 9, by using the analysis result for each area in the frame image as the local information, it is possible to obtain text-based detailed information that is not included in the result (global information) of analyzing the entire frame image and that clearly describes the positional relationship between the detected objects. From these information, it is possible to improve the accuracy of identifying a scene in which the user’s desired object appears without leaking information in the processing of the secondary scene identification circuitry 302 on the cloud server 3 side in the subsequent stage. For example, in the case where a dangerous animal is set as an object to be detected, even if there is a possibility that the dangerous animal cannot be detected from the global information, it is possible to detect whether or not the dangerous animal is present in a specific area in the frame image using the local information.

The primary scene identification circuitry 102 may not designate specific areas (upper left, upper right, lower left, and lower right) and cause the language model M11 to analyze images corresponding to the designated areas as shown in FIG. 9, but may input four images, which are obtained by dividing a frame image into four areas, to the language model M11 together with an instruction sentence for analyzing these four images and cause the language model M11 to analyze these images.

As illustrated in FIGS. 8 and 9, the edge device 1 first performs analysis using the LLM and the VLM and determines whether or not a user’s desired object appears in the frame image using the text information. Thus, it is possible to reduce the amount of data to be subjected to the identification process of the user’s desired scene and the amount of data to be transmitted to the cloud server 3. However, when the global information is described in the text format, the global information obtained by analyzing the entire frame image as a target may not necessarily focus on a person, an object, or the like to be noted according to an installation purpose of the camera 2 even if the global information has contents in which an outline of the entire frame image is objectively and accurately described. In the case where a camera 2 in the target space is installed for crime prevention such as detection of danger of a person in a facility or around the facility, a supervisor (of the target space) who understands the purpose can select information while viewing the entire frame image. However, it is difficult for the supervisor to detect a danger by constantly viewing an image for a long time, which leads to the supervisor’s lack of focus or misjudgment. Therefore, it is required to be able to automatically and accurately identify or specify a scene to be focused on. In the edge device 1 of the image processing system 100, as illustrated in FIGS. 8 and 9, it is possible to reduce the amount of data to be used for the identification process of the user’s desired scene and the amount of data to be transmitted to the cloud server 3 side by using the text information, and it is possible to accurately identify a scene to be noted by converting events shown in each frame to text by using the language model M11 separately for the global information and the local information.

In addition, as described above, because the scene identification process is distributed between the edge device 1 and the cloud server 3, it is possible to reduce the processing load of the edge device 1 having relatively small calculation resources. Because the text information is transmitted to the cloud server 3 after the primary scene identification process is performed by the edge device 1, it is possible to reduce the amount of communication while reducing the security risk and considering the personal information as compared with transmitting the captured frame image to the cloud server 3.

The image processing system 100 can display scenes, in which the user’s desired object appears, on the display 43 of the client 4, based on the time information stored in the storage unit 31 of the cloud server 3 by the secondary scene identification circuitry 302. FIG. 10 is a flowchart illustrating an example of a display control procedure in the image processing system 100. When a user (for example, an operator who centrally and remotely manages chain stores) accesses the cloud server 3 using the client 4, the processing unit 30 of the cloud server 3 starts the following processing as the selection operation circuitry 303 and the image display control circuitry 304.

The processing unit 30 of the cloud server 3 receives data specifying a target space from the client 4 as the selection operation circuitry 303 (step S331). In step S331, the processing unit 30 receives account data of the user, identification data or a name of the target space, and the like. In step S331, the processing unit 30 may receive a selection from the list of the identification data of the edge devices 1 which the user is allowed to access with the account data used when the user accesses the cloud server 3 through client 4, or the list of the identification data or the names of the target spaces corresponding to the above-described allowed edge devices 1.

The processing unit 30 specifies the identification data of the edge device 1 corresponding to the target space specified by the received data (step S332), and reads the global information, the local information, and the time information, which are associated with the specified identification data of the edge device 1, from the storage unit 31 (step S333). In step S333, the processing unit 30 may read continuous time information from the storage unit 31.

The processing unit 30 receives a search word corresponding to a user's desired object (viewing target) from the client 4 as the selection operation circuitry 303 (step S334). The processing unit 30 extracts global information or local information matching the text of the search word from the global information and the local information read in step S333 as the image display control circuitry 304 (step S335). The matching of the global information or the local information with the text of the search word may include a case where the global information or the local information includes the search word, a case where the global information or the local information includes a synonym for the search word, and the like.

The processing unit 30 designates time information corresponding to the extracted global information or local information, and transmits acquisition requests for thumbnail images of frame images corresponding to the designated time information to the edge device 1 identified by the associated identification data (step S336). The processing unit 30 causes the display 43 of the client 4 to display a list of thumbnail images transmitted in response to the acquisition requests (step S337), and ends the processing.

In the processing illustrated in FIG. 10, the steps S334 and S335 related to the search may be omitted, and a list of thumbnail images corresponding to the time information read in step S333 may be displayed in step S337.

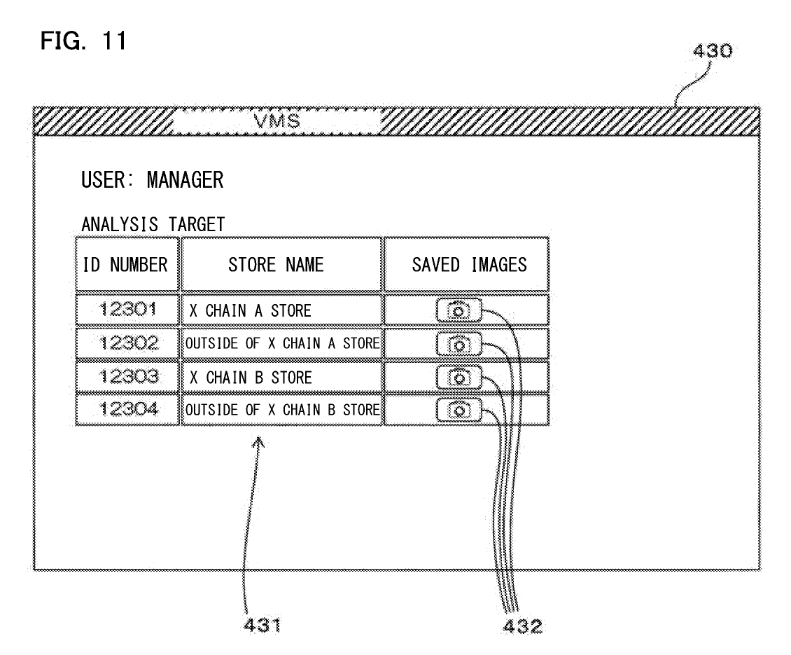

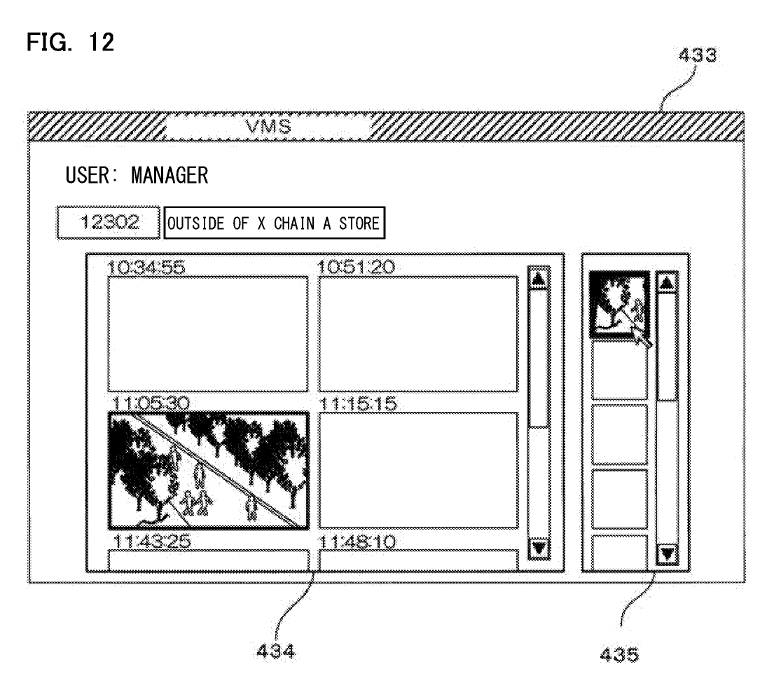

FIGS. 11 and 12 are explanatory diagrams illustrating display examples of images on the client 4. FIGS. 11 and 12 illustrate an example in which a screen provided by the function of the Web server of the cloud server 3 is displayed by the function of the Web browser included in the client program P4 in response to access from the processing unit 40 of the client 4. On the screen 430 illustrated in FIG. 11, a list 431 of target spaces permitted to be browsed by the user who operates the client 4 is displayed. The list 431 includes interfaces 432 with links to image display screens 433 each of which displays images saved (stored) for each of the target spaces. In the example of FIG. 11, a list 431 of “X chain A store”, “outside of X chain A store”, “X chain B store”, “outside of X chain B store” is displayed.

FIG. 12 is a diagram illustrating an example of the image display screen 433. The image display screen 433 illustrated in FIG. 12 is displayed when the interface 432 for the “outside of X chain A store” is selected from the list 431 illustrated in FIG. 11 by the user using the operation unit 44.

The image display screen 433 includes an area 434 displaying a list of thumbnail images corresponding to the scenes identified by the primary scene identification circuitry 102 and the secondary scene identification circuitry 302, and an area 435 displaying a list of images obtained by extracting areas corresponding to local information of grounds for identifying the scenes. In the image display screen 433, when an image included in the area 435 is selected, the thumbnail image of the original scene corresponding to the selected image is highlighted in the area 434. Text indicating time information is shown in each thumbnail image of the area 434. When a selection operation is performed on each image in the area 434 by using the operation unit 44, the client 4 can acquire a moving image including the scene corresponding the selected image from the image information stored in the edge device 1 via the cloud server 3 and display the moving image on the display 43.

In the image processing system 100 of the first embodiment, the communication amount can be reduced by the configuration in which only the text information such as the time information and the local information is transmitted from the edge device 1 to the cloud server 3 and stored in the cloud server 3, instead of transmitting the frame image or the moving image from the edge device 1 to the cloud server 3 and making the cloud server 3 store the frame image or the moving image. Further, according to the configuration of the image processing system 100 of the first embodiment, it is possible to display images necessary for a user on the display 43 of the client 4 without storing an image of a target such as a customer to be captured in each space in the cloud server 3. Accordingly, the image processing system 100 can make it possible for the user to view a frame image or a moving image in which it is determined that a specific object appears with higher accuracy while considering personal information.

As described above, according to the image processing system 100 of the first embodiment, global information which is outline information about whole of a frame image, local information which is information about each area in the frame image, and time information corresponding to the frame image are extracted from one frame image or a plurality of temporally continuous frame images. This makes it possible to obtain information about detailed content of the frame image (not only outline information about whole of the frame image but also information about each area in the frame image). Accordingly, it is possible to accurately identify a user's desired scene using the obtained information about detailed content of the frame image.

### Modifications

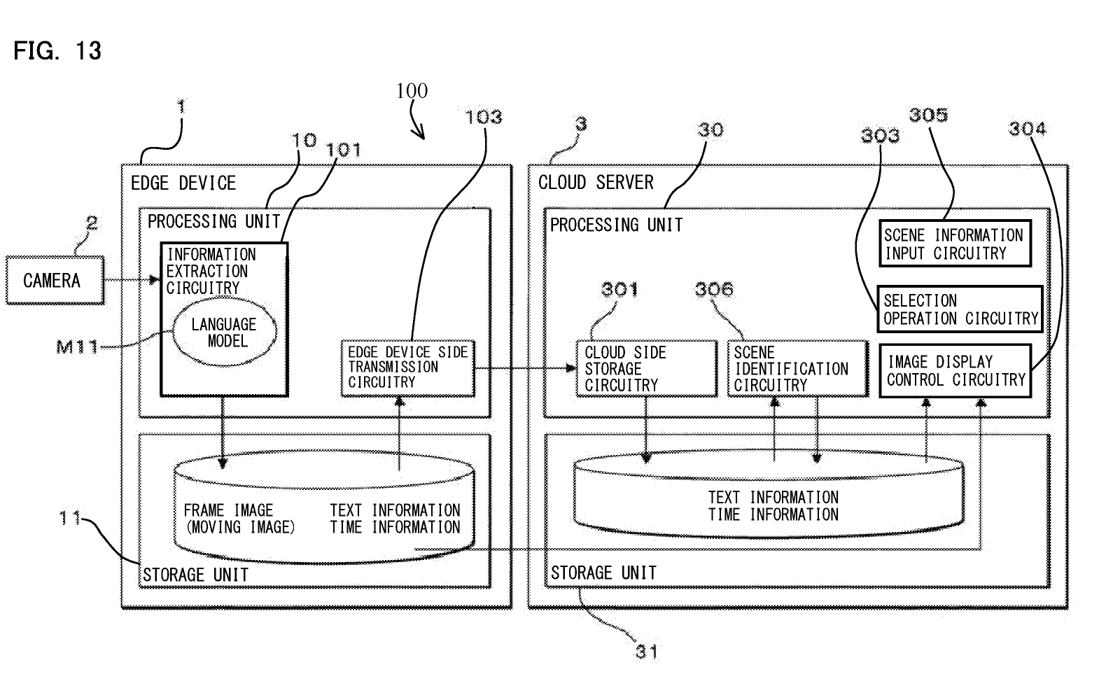

In the first embodiment, the scene identification processing is distributed between the primary scene identification circuitry 102 of the edge device 1 and the secondary scene identification circuitry 302 of the cloud server 3. However, the present invention is not limited to this, and a user's desired scene may be identified by only one scene identification circuitry on the cloud server 3 side. FIG. 13 is a functional block diagram of an image processing system 100 according to a modification of the first embodiment.

In the modification, the processing unit 10 of the edge device 1 functions as the information extraction circuitry 101 and the edge device side transmission circuitry 103. The processing unit 10 transmits the global information and the local information extracted by the information extraction circuitry 101 for each frame image from the edge device side transmission circuitry 103 to the cloud server 3 regardless of whether or not a user's desired object is likely to appear in the frame image from which the global and local information is extracted.

In the modification, the processing unit 30 of the cloud server 3 functions as the cloud side storage circuitry 301, a scene identification circuitry 306, the selection operation circuitry 303, the image display control circuitry 304, and the scene information input circuitry 305. In the modification, the scene identification circuitry 306 combines the functions of the primary scene identification circuitry 102 and the secondary scene identification circuitry 302 of the first embodiment, and a detailed description thereof will be omitted. The scene identification circuitry 306 identifies a user’s desired scene using the global information, the local information, and the time information for each frame image stored in the storage unit 31, and stores only the time information corresponding to the identified scene in the storage unit 31.

Also in the modified example, because only text-based information is transmitted from the edge device 1 to the cloud server 3, it is possible to reduce communication traffic while considering the personal information. In addition, because it is possible to obtain information about detailed content of the frame image (not only outline information about whole of the frame image but also information about each area in the frame image), it is possible to accurately identify a user's desired scene using the obtained information about detailed content of the frame image.

### Second Embodiment

In the first embodiment, as shown in FIG. 9, local information is obtained for each of four areas into which a frame image is divided. In the second embodiment, an object to appear in a user's desired scene is detected first, and local information is obtained with reference to a bounding box of the detected object.

The image processing system 100 according to the second embodiment is the same as the image processing system 100 according to the first embodiment except for the detailed processing when obtaining the local information. Therefore, in the image processing system 100 of the second embodiment, the same reference numerals are given to the same components as those of the first embodiment, and detailed description thereof will be omitted.

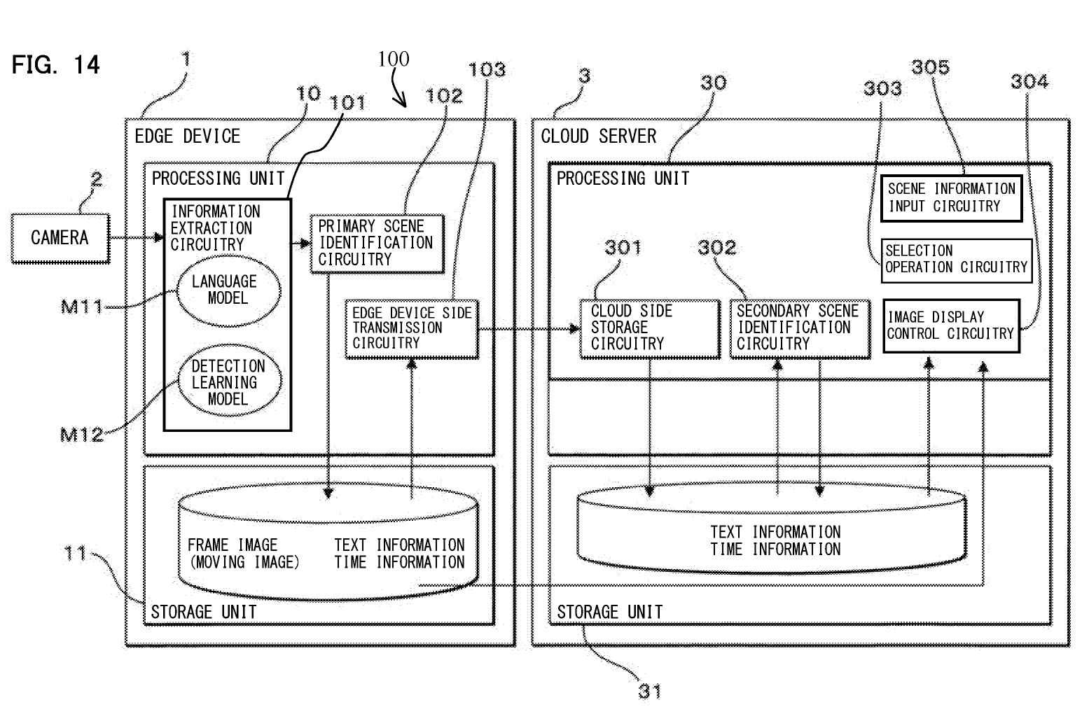

FIG. 14 is a functional block diagram of the image processing system 100 according to the second embodiment. In the second embodiment, the information extraction circuitry 101 uses not only the language model M11 but also the detection learning model M12. In the second embodiment, as the information extraction circuitry 101, the processing unit 10 first uses the detection learning model M12 for detecting the user's desired object for the acquired frame image to extract an area in which the user's desired object is likely to appear. The detection learning model M12 is selected from detection learning models such as a person detector, a head detector, a face detector, an animal detector, and a specific device detector, which are stored in the database 310, according to a user's desired object (a person, an animal, a vehicle, a device, or the like) set for each target space, and is stored in the storage unit 11. Further, an object detection process using the detection learning model M12 is deployed in the edge device 1. The information extraction circuitry 101 obtains a detection result (coordinate data of a region in which an object is captured, and accuracy) output from the detection learning model M12. In the second embodiment, when the user's desired object is not detected by the detection learning model M12, the information extracting circuitry 101 discards the target frame image without executing the subsequent processing.

Also in the second exemplary embodiment, as in the first embodiment, the information extraction circuitry 101 gives an instruction to the language model M11 so that the language model M11 outputs a sentence or one or more words describing a person or an object appearing in the entire frame image, and obtains text-based information output from the language model M11 as global information that is outline information about whole of the frame image. In the second embodiment, the information extraction circuitry 101 uses the detection result obtained from the detection learning model M12 to obtain information estimated from the attribute, arrangement, and the like of a user's desired object appearing in the frame image as local information in a text format. Specifically, the information extraction circuitry 101 designates a bounding box (a range in the frame image) indicating a region in which the object indicated by the detection result appears, instructs the language model M11 to output a sentence or one or more words describing the user's desired object appearing in the designated range, and obtains text-based information output from the language model M11 as local information regarding the target object.

Also in the second exemplary embodiment, the information extraction circuitry 101 extracts text-based outline information such as “Three people are walking.”, “A plurality of autumn trees appear.”, and “A specific animal appears behind a tree.” from a frame image as the global information about whole of the frame image.

When a “person” is designated as a user's desired object, the information extraction circuitry 101 extracts text-based information such as “The detected person (who is from 50 to 69 years old) is walking forward. There are three trees by the person. A specific animal is in the shade of trees.“, “The detected person (who is from 30 to 49 years old and wearing a hat) is walking to the far side. There is another person (wearing glasses) by the person.“, “A detected person (who is from 30 to 49 years old and wearing glasses) is walking to the far side. There is another person (wearing a hat) by the person.”, or “The detected person (who is from 20 to 29 years old) is walking to the far side. There is a dog by the person.“ for the detected person from a frame image as the local information regarding a specific area or object in the frame image. In the case where there are a plurality of detected persons, the persons can be identified by assigning IDs to the respective persons, and in the case where the same person appears over a plurality of frame images, the same ID can be assigned to the person by face recognition to follow the person.

As described above, when acquiring local information, the information extraction circuitry 101 according to the second embodiment designates a bounding box to obtain the local information. Without being limited thereto, the information extraction circuitry 101 may perform object detection on a frame image in advance using the detection learning model M12, input an image, in which grid lines dividing the frame image and a bounding box of each object detected by the object detection are drawn on the frame image, to the language model M11 such as VLM, and output local information in a text format. In this way, the local information can be extracted based on the positional relationship between the grid lines and the bounding box of each object. Accordingly, for example, regarding the detected “person”, it is possible to obtain the local information showing the person recognition results in a specific area of the frame image such as “A person (who is from 50 to 69 years old) detected in the upper left area divided by the grid lines is walking forward.” Also in the second embodiment, the information extraction circuitry 101 may extract, from a plurality of temporally continuous frame images (that is, a moving image), global information, local information and time information corresponding to the plurality of temporally continuous frame images.

In the second embodiment, as in the first embodiment, the primary scene identification circuitry 102 identifies a scene in which a user's desired object appears in the target frame image, based on the global information or the local information extracted by the information extraction circuitry 101. Because the information extraction circuitry 101 uses the detection learning model M12 and the language model M11, the primary scene identification circuitry 102 of the second embodiment can identify a scene by an attribute or a motion (walking, stopping, or the like) of a detected object in slightly more detail than the scene identification criteria in the primary scene identification circuitry 102 of the first embodiment. By the function of the primary scene identification circuitry 102, the processing unit 10 stores the frame image corresponding to the identified scene in the storage unit 11 in association with the time information extracted by the information extraction circuitry 101. The primary scene identification circuitry 102 stores a moving image for a predetermined time before and after the frame image corresponding to the identified scene into the storage unit 11. When the processing unit 10 identifies that the user's desired object does not appear in the target frame image based on the output from the information extracting circuitry 101 as the primary scene identification circuitry 102, the processing unit 10 ends the processing for the target frame image without executing the subsequent processing for the target frame, and executes the processing for the next frame image.

In the second embodiment, the other functions, that is, the functions of the edge device side transmission circuitry 103, the cloud side storage circuitry 301, and the secondary scene identification circuitry 302 are the same as those in the first embodiment, and detailed description thereof will be omitted.

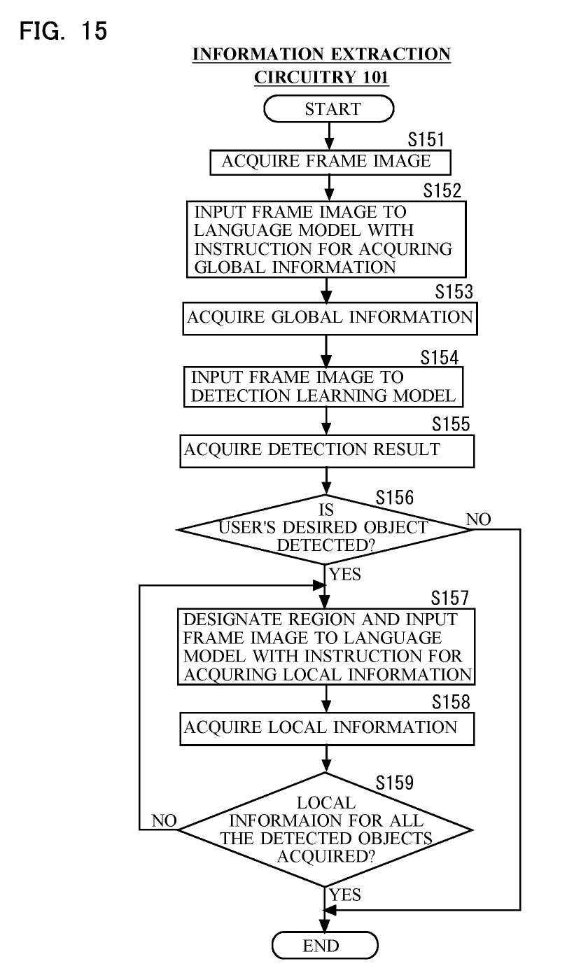

FIG. 15 is a flowchart illustrating an example of procedures to be performed by the information extraction circuitry 101 according to the second example embodiment. The procedures of the primary scene identification circuitry 102 and the edge device side transmission circuitry 103 of the processing unit 10 in the second embodiment is the same as the procedures illustrated in FIG. 6 of the first embodiment, and thus detailed description thereof will be omitted.

The processing unit 10 of the edge device 1 of the second embodiment acquires a frame image from the camera 2 by the information extraction circuitry 101 (step S151).

The processing unit 10 inputs the acquired frame image to the language model M11 together with an instruction for acquiring global information (step S152). In step S152, the processing unit 10 creates a sentence such as “Analyze what appears in this image.” as an instruction for acquiring the global information, and inputs the sentence to the language model M11 together with the frame image.

The processing unit 10 acquires text information, which is a sentence or one or more words output from the language model M11 in response to the input in step S152, as global information (step S153).

The processing unit 10 of the second embodiment inputs the acquired frame image to the detection learning model M12 (step S154) to acquire a detection result (step S155). The processing unit 10 determines whether or not the user’s desired object is detected in the acquired frame image using the detection learning model M12 by the function of the information extraction circuitry 101 (step S156).

When determining that the user’s desired object is not detected in the acquired frame image (NO in step S156), the processing unit 10 ends the processing for the acquired frame image. The acquired frame image and global information does not have to be stored in the storage unit 11.

When determining that the user’s desired object is detected in the acquired frame image (YES in step S156), the processing unit 10 designates a region (bounding box) in which the object indicated by the detection result acquired in step S155 appears, and inputs the frame image to the language model M11 together with an instruction for acquiring local information (step S157). In step S157, as an “instruction” for acquiring local information, the processing unit 10 designates a region in which the object appears, generates a sentence such as “Analyze what appears in the designated portion of this image.” for the frame image, and inputs the sentence to the language model M11 together with the frame image.

The processing unit 10 acquires text information, which is a sentence or one or more words output from the language model M11 in response to the input in step S157, as local information (step S158).

In accordance with the detection result acquired in step S155, the processing unit 10 determines whether local information for all the objects detected as the user’s desired object has been acquired (step S159). When determining that local information does not have been acquired for all the detected objects (NO in step S159), the processing unit 10 returns the process to step S157 to execute the process for another object in the frame image.

When determining that local information for all the detected objects has been acquired (YES in step S159), the processing unit 10 ends the processing as the information extraction circuitry 101.

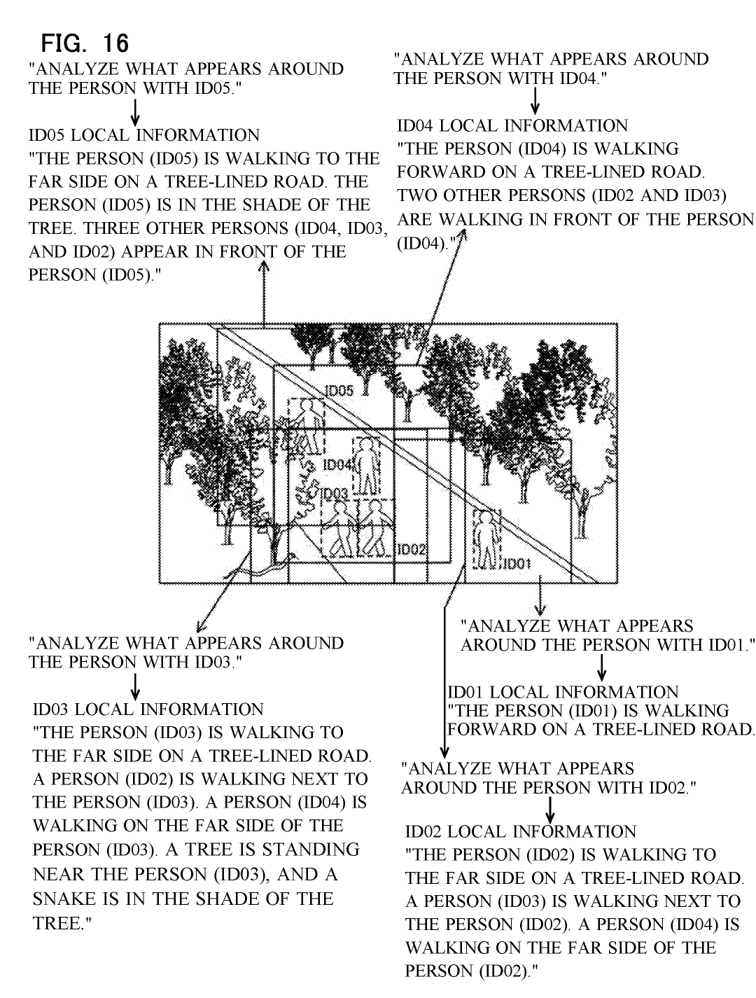

FIG. 16 is an explanatory diagram of the local information in the second embodiment. FIG. 16 shows an example of the local information for the frame image shown in FIG. 8 of the first embodiment. In FIG. 16, a bounding box of the detected object (person) is indicated by a broken line. In the frame image shown in FIG. 16, five persons (objects) of ID01 to ID05 are detected. The local information shown in FIG. 16 indicates an example of local information obtained by designating areas corresponding to the detected objects of ID01 to ID05. In the example of FIG. 16, the local information is output from the language model M11 in response to an instruction such as “Analyze what appears around the person with ID01.” for each of the objects detected in the frame image.

In the example of FIG. 16, the local information obtained by designating the person (object) of ID01 is “The person (ID01) is walking forward on a tree-lined road.” In this local information, more detailed information such as the direction and movement of the designated person is described. The local information obtained by designating the person of ID02 is “The person (ID02) is walking to the far side on a tree-lined road. A person (ID03) is walking next to the person (ID02). A person (ID04) is walking on the far side of the person (ID02).” This local information clearly describes the direction and the movement of the designated person, and the positional relationship between the designated person and other persons. The local information obtained by designating the person of ID03 is “The person (ID03) is walking to the far side on a tree-lined road. A person (ID02) is walking next to the person (ID03). A person (ID04) is walking on the far side of the person (ID03). A tree is standing near the person (ID03), and a snake is in the shade of the tree.” This local information describes existence of a small dangerous animal which is not described in the global information, and the positional relationship between the small dangerous animal and the detected person in detail.

The local information obtained by designating the person of ID04 is “The person (ID04) is walking forward on a tree-lined road. Two other persons (ID02 and ID03) are walking in front of the person (ID04).” This local information clearly describes the direction and the movement of the designated person, and the positional relationship between the designated person and other persons. The local information obtained by designating the person of ID05 is “The person (ID05) is walking to the far side on a tree-lined road. The person (ID05) is in the shade of a tree. Three other persons (ID04, ID03, and ID02) appear in front of the person (ID05).” This local information clearly describes the movement of the designated person, and the positional relationship between the designated person and trees or other persons.

As shown in FIG. 16, the image processing system 100 of the second embodiment uses text-based information, which is obtained by analyzing a target frame image using the language model M11 based on an object detected in the target frame image, as local information. Thus, it is possible to obtain text-based detailed information that is not included in the results of analyzing the entire frame image, and that clearly describes the positional relationship between the detected objects.

Also in the image processing system 100 of the second embodiment, the communication amount can be reduced by the configuration in which only the text-based information such as the time information and the local information is transmitted from the edge device 1 to the cloud server 3 and stored in the cloud server 3, instead of transmitting the frame image and the moving image from the edge device 1 to the cloud server 3 and making the cloud server 3 store the frame image and the moving image. In addition, according to the configuration of the image processing system 100 of the second embodiment, it is possible to display images necessary for a user on the display 43 of the client 4 without storing an image of a target such as a customer to be captured in each space into the cloud server 3. Further, in the image processing system 100 of the second embodiment, it is possible to specify a scene more accurately by using local information which is extracted by performing AI-powered image description for a frame image with paying attention to a range in which a user's desired object is detected in the frame image. As described above, also in the second embodiment, the image processing system 100 can make it possible for the user to view a frame image or a moving image in which it is determined that a specific object appears with higher accuracy while considering personal information.

### Third Embodiment

In the third embodiment, the secondary scene identification circuitry 302 on the cloud server 3 side identifies a user's desired scene using the LLM based on the global information, the local information, and the time information accumulated in the storage unit 31. The image processing system 100 according to the third embodiment is the same as the image processing system 100 according to the first embodiment or the second embodiment except for the processing of the secondary scene identification circuitry 302. Therefore, in the image processing system 100 of the third embodiment, the same reference numerals are given to the same components as those of the first embodiment and the second embodiment, and detailed description thereof will be omitted.

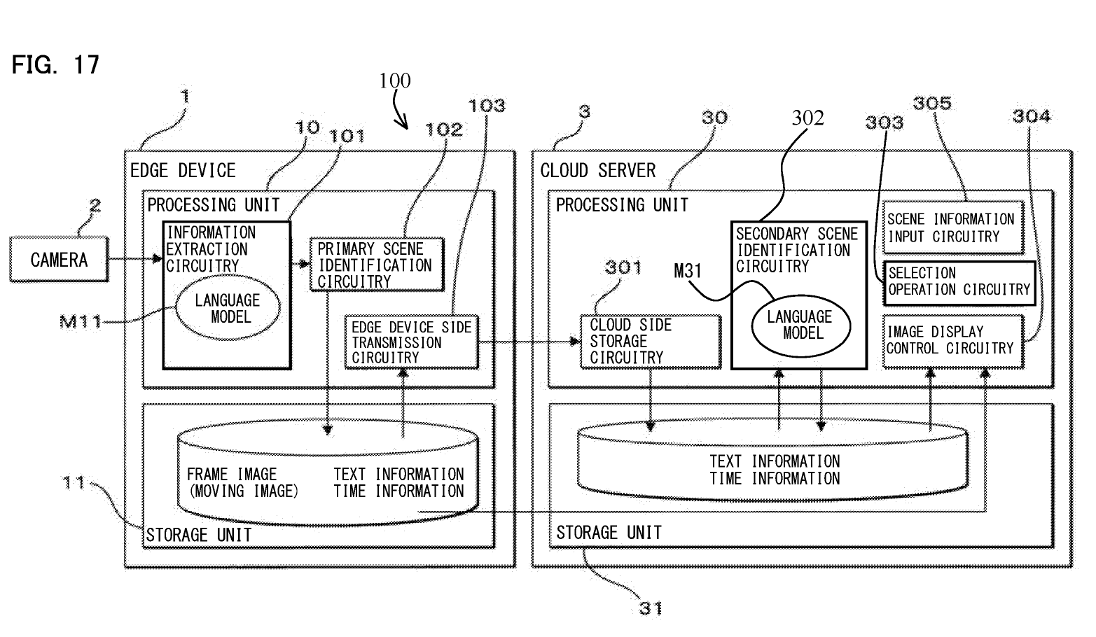

FIG. 17 is a functional block diagram of the image processing system 100 according to the third embodiment. In the third embodiment, the secondary scene identification circuitry 302 on the cloud server 3 side identifies a user's desired scene using a language model M31. Specifically, the secondary scene identification circuitry 302 uses the language model M31 (LLM) to identify the time information of the frame image, in which the user’s desired object appears, based on the text-based global information or local information regarding each frame image stored in the storage unit 31 by the cloud side storage circuitry 301. The secondary scene identification circuitry 302 may identify the scene from each of the global information and the local information, or may use a combination of the global information and the local information corresponding to the same time information. The secondary scene identification circuitry 302 provides the LLM with global information and/or local information for each piece of stored time information (corresponding to frame images) and a text-based instruction for searching for a user’s desired scene, and identifies the user’s desired scene using an answer from the LLM.

In the third embodiment, the edge device 1 executes the procedures illustrated in FIG. 6 as in the first embodiment, or the procedures illustrated in FIG. 15 of the second embodiment. Also in the third embodiment, the cloud side storage circuitry 301 of the cloud server 3 executes the procedures illustrated in FIGS. 6 and 7 as in the first and second embodiments. On the other hand, the secondary scene identification circuitry 302 executes the following procedures, different from the first embodiment.

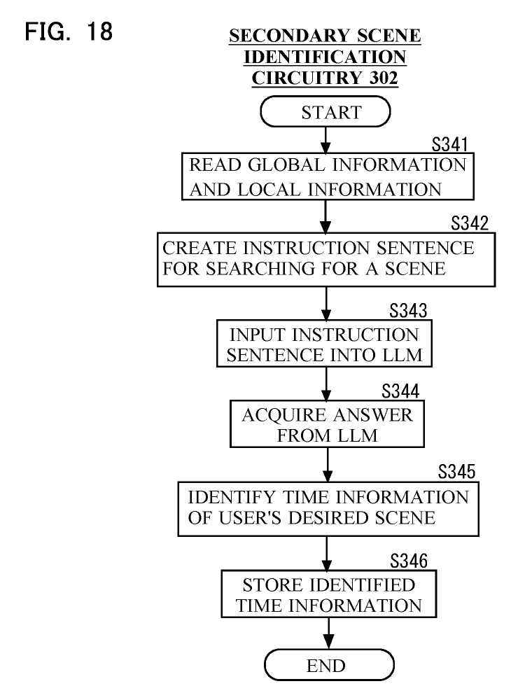

FIG. 18 is a flowchart illustrating an example of procedures to be performed by the secondary scene identification circuitry 302 in the third embodiment. The processing unit 30 of the cloud server 3 executes the following procedures by the function of the secondary scene identification circuitry 302 in parallel with procedures by the edge device 1.

The processing unit 30 executes the following procedures each time a piece of global and local information is accumulated in the storage unit 31. The processing unit 30 may execute the following procedures each time frame images for a predetermined time such as 10 minutes, 30 minutes, 1 hour, 12 hours, or 24 hours are stored in the edge device 1, or may execute the following procedures each time processing on a frame image is executed in the edge device 1.

The processing unit 30 reads the global information and the local information associated with a piece of the time information stored in the storage unit 31 by the function of the secondary scene identification circuitry 302 (step S341). The processing unit 30 creates an instruction sentence for searching for a scene in which a user’s desired object appears (step S342), and inputs the created instruction sentence into the LLM (language model M31) together with the read global information and local information as search targets (step S343).

In step S342, the processing unit 30 creates the instruction sentence in a natural language such as “Find a scene in which a person is in a dangerous state based on the attached text information, and tell me time information for specifying the scene.” The processing unit 30 may perform a search not for each frame image but for scenes over a certain period of time (a plurality of temporally continuous frame images), using an instruction sentence such as “Find a scene in which a person is in the same place for five minutes or more based on attached text information, and tell me time information for specifying the scene.” In the case where the processing unit 30 identifies a user’s desired scene from scenes over a certain period of time (a plurality of temporally continuous frame images) as described above, it is desirable for the secondary scene identification circuitry 302 to input the text-based global information, local information, and time information corresponding to the plurality of temporally continuous frame images to the LLM all together, and identify one or more frame images corresponding to the user’s desired scene (output the time information of the one or more frame images corresponding to the user’s desired scene). In the case where the processing of identifying whether or not each of the plurality of temporally continuous frame images corresponds to the user’s desired scene is collectively performed for the plurality of frame images as described above, the secondary scene identification circuitry 302 may identify one or more frame images corresponding to the user’s desired scene by inputting only the text-based local information and the time information for these frame images to the LLM.

The processing unit 30 acquires an answer from the LLM (the language model M31) (step S344). The processing unit 30 identifies the time information of the user’s desired scene from the acquired answer by the function of the secondary scene identification circuitry 302 (step S345). The processing unit 30 stores the identified time information in the storage unit 31 (step S346), and ends the scene identification processing. The processing unit 30 may keep storing the global information and the local information corresponding to the time information identified in step S345 for search or may delete the global information and the local information. The processing unit 30 may delete time information other than the time information identified in step S345 and the global and local information corresponding to the identified time information from the storage unit 31.

In the image processing system 100 according to the third embodiment, by the function of the secondary scene identification circuitry 302 that performs the above-described processing (in particular, inputting the text-based global information, local information, and time information for a plurality of temporally continuous frame images to the LLM collectively to identify one or more frame images corresponding to a user’s desired scene), it is possible to search for a frame image corresponding to the global information and/or the local information using synonyms or a frame image corresponding to a scene that evokes the words included in these information as a context using the LLM rather than searching for global information and local information including words corresponding to the setting information for identifying a user’s desired scene. This increases the possibility of accurately identifying a user’s desired scene.

Also in the image processing system 100 of the third embodiment, only text-based information which is the time information, the local information, and the global information is transmitted from the edge device 1 to the cloud server 3, and the frame image or the moving image is not stored in the cloud server 3. Thus, it is possible to consider the personal information. Because only text-based information is transmitted from the edge device 1 to the cloud server 3, the communication amount can be significantly reduced as compared with the case where the image information is transmitted. When the cloud server 3 having abundant calculation resources identifies a scene in which a user’s desired object appears for a frame image group, the identification is highly accurate. However, by the analysis using the LLM in the image processing system 100 of the third embodiment, it is possible to accurately identify the user’s desired scene while placing importance on consideration of personal information and reduction of communication traffic.

These and other modifications will become obvious, evident or apparent to those ordinarily skilled in the art, who have read the description. Accordingly, the appended claims should be interpreted to cover all modifications and variations which fall within the spirit and scope of the present invention.

1. An image processing system comprising:
an information extraction circuitry configured to extract, from one frame image or a plurality of temporally continuous frame images, local information which is information about a predetermined area or each object in the frame image and time information corresponding to the frame image; and
a scene identification circuitry configured to identify a user's desired scene based on the local information and the time information extracted by the information extraction circuitry.

2. The image processing system according to claim 1, wherein
the local information and the time information are text-based information, and
the scene identification circuitry identifies the user's desired scene based on the local information and the time information in text format.

3. The image processing system according to claim 2, wherein the local information is the text-based information obtained by inputting the frame image into a vision language model (VLM).

4. The image processing system according to claim 2, wherein the scene identification circuitry inputs the local information in the text format into a large language model (LLM) to identify a frame image corresponding to the user's desired scene.

5. The image processing system according to claim 3, wherein the scene identification circuitry inputs the local information and the time information in the text format into a large language model to identify a frame image corresponding to the user's desired scene.

6. An image processing system comprising:
an information extraction circuitry configured to extract, from one frame image or a plurality of temporally continuous frame images, global information which is outline information about whole of the frame image, local information which is information about a predetermined area or each object in the frame image, and time information corresponding to the frame image; and
a scene identification circuitry configured to identify a user's desired scene based on the global information, the local information, and the time information extracted by the information extraction circuitry.

7. The image processing system according to claim 6, wherein
the global information, the local information, and the time information are text-based information, and
the scene identification circuitry identifies the user's desired scene based on the global information, the local information, and the time information in the text format.

8. The image processing system according to claim 7, wherein the global information and the local information are text-based information obtained by inputting the frame image into a vision language model (VLM).

9. The image processing system according to claim 7, wherein the scene identification circuitry inputs the global information, the local information, and the time information in the text format into a large language model (LLM) to identify a frame image corresponding to the user's desired scene.

10. The image processing system according to claim 8, wherein the scene identification circuitry inputs the global information, the local information, and the time information in the text format into a large language model to identify a frame image corresponding to the user's desired scene.

11. The image processing system according to claim 9, wherein the scene identification circuitry combines the global information and the local information in the text format to input into the large language model.

12. The image processing system according to claim 1, wherein
the frame image is divided into a plurality of image areas, and
the local information is generated based on information obtained from at least one of the plurality of image areas.

13. The image processing system according to claim 12, wherein the local information is text-based information obtained by inputting the frame image, which is divided into a plurality of image areas by at least one grid line, into a vision language model.

14. The image processing system according to claim 1, wherein
the local information is information extracted from a bounding box of each object detected by object detection performed on the frame image in advance.

15. The image processing system according to claim 13, wherein the local information is text-based information obtained by inputting the frame image, on which the at least one grid line and a bounding box of each object detected by object detection performed on the frame image in advance are drawn, into a vision language model.

16. The image processing system according to claim 15, wherein the local information is extracted based on a positional relationship between the at least one grid line and the bounding box of each object.

17. The image processing system according to claim 1, further comprising a scene information input circuitry configured to input scene information which is information about the user's desired scene,
wherein the scene identification circuitry identifies a scene corresponding to the scene information input by the scene information input circuitry.

18. The image processing system according to claim 1, further comprising an image display control circuitry configured to control so as to extract the frame image corresponding to the user's desired scene identified by the scene identification circuitry from a moving image including the frame image and display the extracted frame image on a display.

19. The image processing system according to claim 1, wherein
the image processing system comprises an edge device side system and a cloud side system,
the edge device side system comprises the information extraction circuitry, and
the cloud side system comprises the scene identification circuitry.

20. A non-transitory computer readable recording medium for recording an image processing program to cause a computer to perform a process including the steps of:
extracting, from one frame image or a plurality of temporally continuous frame images, local information which is information about a predetermined area or each object in the frame image and time information corresponding to the frame image; and
identifying a user's desired scene based on the local information and the time information.
